(19) United States
(12) Patent Application Publication
(10) Pub. No.: US 2004/0073804 A1
(43) Pub. Date: Apr. 15, 2004

(54) Computation integration on demand

(76) Inventor: Matthew Scott Primous, Penfield, NY (US)

Correspondence Address: Matthew Scott Primous, 1 Holley Brook Drive, Penfield, NY, 14526, US

(21) Appl. No.: 10/421,035

(22) Filed: Apr. 24, 2003

Related U.S. Application Data
(60) Provisional application No. 60/418,265, filed on Oct. 15, 2002.

(51) Int. Cl. H04L 9/00

(52) U.S. Cl. 713/186

(57) ABSTRACT

This invention combines optical technology of nanotechnology to produce accessible and reliable data processing. The invention increase security by demanding three key chips to access it. The key chips are the central controls and powersouce of the invention. The invention will revolutionize the way computers are used. The technology suggests advancement of previous computer technology to simplicity. It uses wireless technology to provide greater accessibility. The main claim of this invention is to provide simple data processing.

### CROSS-REFERENCE TO RELATED APPLICATIONS

This application is a continuation of application Serial No. 519990, filed on Oct. 15, 2002 entitled ‘Millennium Edition Voting Booth.’

This application is a continuation of application Serial No. 60/418,265 filed on Oct. 15, 2002 entitled ‘Millennium Edition Voting Booth.’

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention deals with computer hardware and software. The problem with computer hardware is reducing the hardware, designing it to increase innovation, and security. The problem with software is developing computer software that increases security on access while providing simple, reliable, and comfortable access.

This problem has been unsolved. Many computer hardware and software are too small and complex for individuals to understand their usefulness. They lack one thing or the other, either simplicity or reliability. Others tired to develop the keyboard and mouse of hardware to do more programming and provide more flexibility but it gives the individual a false sense of freedom and security. Everything has a limited and some things need a limit. They haven't reduced the problem with security, accuracy, and innovation but instead went around the problem. They haven't provided reliability. The computer hardware and software today haven't yet provided enough protection for individuals' confidence. Their advancement is not meeting the demands today. They haven't advanced to this phase yet. They recycled old ideas; the technology I believe is there but not yet used.

In a world of increasing violence and lawlessness, our government, communities, and businesses need better access with more security. The government wants better solutions for security and reliability. In order for the government to maintain democracy in the world, it needs to avoid political problems with direct and reliable communications. Communication that will bring confidence and understanding of it's desire to protect its citizens' rights. The government desire to decrease taxes by reducing its budget. Communities need better communication and reliability to protect their neighbors and possessions. In order for a community to survive, disruptive events and meet coming needs cause by youth, disable, and aging individuals. Businesses need more accurate and precise equipment to compete. Business' equipment that will reduce their inventory by lasting them a long time, allowing them to use capital investment on aspects that will increase competition, they can focus on defeating competition with pricing and quality.

### BRIEF SUMMARY OF THE INVENTION

This invention provides comfortable and reliable access while providing high security. The invention is smaller and advance then previous products. This invention developed a new communication between the computer hardware and software. The invention has more innovative solutions for better accuracy and security. The invention is flexible to individuals and maintains security. The invention allows individuals to have choices of communication using voice recognition and touch to download information and process information to the invention. The security access increased by the invention because the invention will work only with the three key chips. It will analyze, verify, and confirm the needs of individuals. This system will make processing simple and available.

### BRIEF DESCRIPTION OF THE SEVERAL VIEWS OF THE DRAWING

The accompanying drawings further describe the invention.

FIG. 1 is an example of the total product together as envisioned.

FIG. 2 is an example of the detachable touch monitor from the processor.

FIG. 3 is an example of the three key chips, which will be the centers of security, power, and control for the machine.

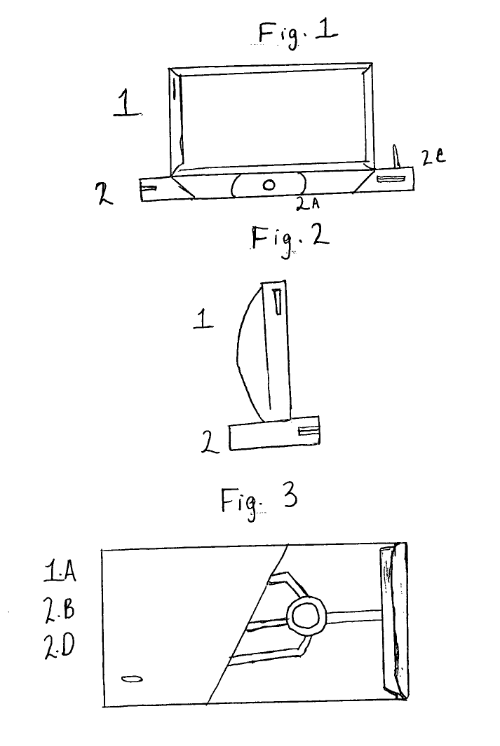

### DETAILED DESCRIPTION OF THE INVENTION

Element 1 is the monitor, which is detachable. It is a touch-screen. It projects images and words from the data information downloaded through its key chip. It's key chip that is Element 1a. The key chip will be entering through the side of the monitor. The key chip of image has the central control over the virtual images and words of the monitor. It controls the amount of power source to the monitor because it has a small, long-lasting battery attached to it with the necessary programs to update and download programming information. It temporarily stores information from the optics and sensory to transmit to the processor. It sends information through the optic laser, which makes it detachable.

Element 2 are the dual processor that has voice activation and processing data to mainframe. The dual processor has an intercom speaker, Element 2a, which communicates the data processing and the information retrieved. The voice recognition, translating of language, and sensing software is on another key chip, Element 2b. This key chip of voice has the software, power source with long-lasting battery, and is the center of controls for this part of the processor; it retrieves information and temporarily stores information to send to processing part of processor. The key chip of voice will be enter through the hard drive on processor' side. The other part of the processor, Element 2c, processes data retrieve from the other key chips and sends them to the mainframe of control through the wireless connection. In order to send the information, the key chip of processing, Element 2d, must be in the hard drive in the front of the processor and it will store the information sought until the information been fully processed to mainframe. It will have a longer storage.

for this invention the most preferred materials will be simple circuit boards for the monitor and processor. Other materials preferred would be optical technology and nanotechnology, the use of simple rams products and multiple components of sensory and storage. The wireless connection preferred is 802.11b Wi-Fi. Phonetics for voice recognition technology in the intercom system. Another preferred materials are from selected rubber, plastic, copper and metal. Simple and medium-sized will be more preferred in building this invention.

Reliability, comfortablilty, security, and portability are main elements to this invention. Simplicity is what makes this product innovative. The above description should not conveyed as limitations on the scope of the invention. Many other variations are possible. Accordingly, the scope of the invention is determined by the claims and their legal equivalents.

What I claim as my invention is:

1- This invention provides security, reliability, and simplicity by allowing individuals to process data information through the voice and touch.

2- Wherein it provides security, battery power, data programming, and access through the key chips, when inserted into their hard drives.

3- Consisting essentially of: nanotechnology, phontics technology, wireless technology, and optical technology to produce accessibility and reliability for individuals.
